(19) United States
(12) Patent Application Publication
(10) Pub. No.: US 2023/0136113 A1
(43) Pub. Date: May 4, 2023

(54) METHODS AND APPARATUS FOR INDICATING COMMON TRANSMISSION CONFIGURATION INDICATOR (TCI) STATE

(71) Applicant: GUANGDONG OPPO MOBILE TELECOMMUNICATIONS CORP., LTD., Dongguan (CN)

(72) Inventor: Li Guo, Allen, TX (US)

(21) Appl. No.: 18/090,363

(22) Filed: Dec. 28, 2022

Related U.S. Application Data
(63) Continuation of application No. PCT/IB21/59214, filed on Oct. 7, 2021.
(60) Provisional application No. 63/088,520, filed on Oct. 7, 2020.

(51) Int. Cl. H04W 72/231; H04W 72/1263; H04L 1/1812

(52) U.S. Cl. CPC H04W 72/231; H04W 72/1263; H04L 1/1812

(57) ABSTRACT

Methods and systems for configuring multiple DL and UL beam operations though one reference signal are provided. In some embodiments, the method includes (1) activating a list of one or more TCI states based on a medium access control (MAC) control element (CE); (2) receiving DL control information (DCI) at a particular scheduling slot; and (3) configuring UL and DL channels. Each TCI state includes a configuration for DL transmission, and/or a configuration for UL transmission. The DCI indicates one of the activated TCI states, which is used to configure both the UL and DL channels.

### CROSS-REFERENCE TO RELATED APPLICATION(S)

This application is a continuation of International Application No. PCT/IB2021/059214 filed on Oct. 7, 2021, which claims the benefit of U.S. Provisional Patent Application Ser. No. 63/088,520, filed Oct. 7, 2020, all of which are incorporated in their entireties herein by reference.

### TECHNICAL FIELD

This application relates to the communications field, and more specifically, to a wireless communications system, method, and device.

### BACKGROUND

Rapid growth in computing technology creates a greater demand for data communication. The increasing demand in turn drives further growth in communication technology, including multi-beam communication or operations. New radio (NR) or 5th generation (5G) communication system supports multi-beam operation on downlink (DL) and uplink (UL) physical channels and reference signals. The NR/5G system supports functions of indicating beams for communication channels Transmission Configuration Indicator (TCI) state. Problems include, when using separate signaling to indicate both UL and DL beam transmission, each serving cell needs a TCI state configuration, which results in large control signaling overhead as well as increasing beam switch latency. Therefore, it is advantageous to have improved methods or systems to address the foregoing issue.

### SUMMARY

The present disclosure provides methods and systems for configuring multiple DL and UL beam operations though one reference signal. In some embodiments, the method can include, for example, (1) activating a list of one or more TCI states based on a medium access control (MAC) control element (CE); (2) receiving DL control information (DCI) at a particular scheduling slot; and (3) configuring UL and DL channels. Each TCI state includes a configuration for DL transmission and/or a configuration for UL transmission. The DCI indicates one of the activated TCI states, which is used to configure the UL and DL channels. Accordingly, the present method can configure multiple DL and UL beam operations though one reference signal.

In some embodiments, configuring the DL channels can include configuring a physical downlink shared channel (PDSCH) and a physical downlink control channel (PDCCH) based on the configuration for DL transmission included in the activated TCI state indicated by the DCI. In some embodiments, configuring the DL channels can include configuring a physical uplink shared channel (PUSCH) and a physical uplink control channel (PUCCH) based on the configuration for UL transmission included in the activated TCI state indicated by the DCI. In some embodiments, the DCI of the present disclosure can have a “1_0” format. In some embodiments, the DCI can have other suitable format such as “0_0” format.

The list of the one or more TCI states can include one or more DL TCI states for common TCI state operation and one or more UL TCI states for common TCI state operation. Each DL TCI state includes a configuration for DL transmission, and each UL TCI state includes a configuration for UL transmission. In some examples, the configuration for the DL transmission can include a quasi co-location (QCL) configuration, and the configuration for the UL transmission can include spatial-relation information for determining an UL spatial transmission filter.

The method can further include determining a Hybrid Automatic Repeat Request (HARQ) acknowledgment (ACK) associated with the DCI, and reporting the determined HARQ-ACK. In some implementations, the HARQ-ACK can be determined based on a timeline method for sending the HARQ-ACK and/or a method of choosing the PUCCH resource index.

For example, in some examples, a terminal device (or user equipment UE) can be requested to provide HARQ-ACK information in response to a DCI format that indicates TCI state(s) for the common TCI state operation. The UE can provide the HARQ-ACK information in response to a first DCI format (which indicates the TCI states for common TCI state operations) after “N” symbols from the last symbol of a PDCCH that provides the first DCI format.

Another aspect of the present disclosure includes a user equipment (UE) configured to (1) activate a list of one or more TCI states based on a MAC CE, and each TCI state includes configurations for downlink (DL) and/or uplink (UL) transmission; and (2) receive DCI (e.g., from a base station or a next generation node B base station, gNB) at a particular scheduling slot, and the DCI indicates one of the activated TCI states. The UE is to configure at least one of: (i) a PDSCH and a PDCCH based on the configuration for DL transmission included in the activated TCI state indicated by the DCI, and (ii) a PUSCH and a PUCCH based on the configuration for UL transmission included in the activated TCI state indicated by the DCI.

In some embodiments, the present method can be implemented by a tangible, non-transitory, computer-readable medium having processor instructions stored thereon that, when executed by one or more processors, cause the one or more processors to perform one or more aspects/features of the method described herein.

### BRIEF DESCRIPTION OF THE DRAWINGS

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

FIG. 1 is a schematic diagram of a wireless communication system in accordance with one or more implementations of the present disclosure.

FIG. 2 is a schematic diagram illustrating a list of TCI states in accordance with one or more implementations of the present disclosure.

FIG. 3 is a flowchart of a method in accordance with one or more implementations of the present disclosure.

FIG. 4 is a flowchart of a method in accordance with one or more implementations of the present disclosure.

FIG. 5 is a schematic block diagram of a terminal device in accordance with one or more implementations of the present disclosure.

### DETAILED DESCRIPTION

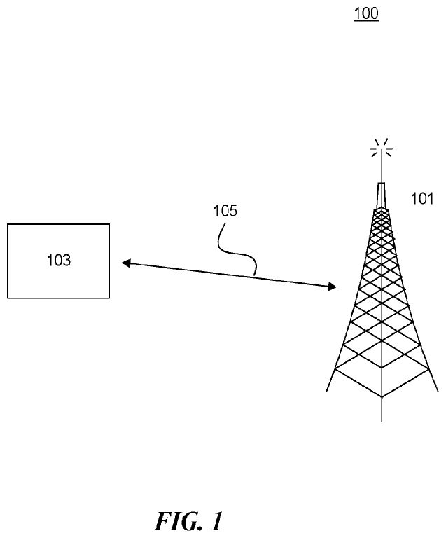

FIG. 1 illustrates a wireless communications system 100 for implementing the present technology. As shown in FIG. 1, the wireless communications system 100 can include a network device (or base station) 101. Examples of the network device 101 include a base transceiver station (Base Transceiver Station, BTS), a NodeB (NodeB, NB), an evolved Node B (eNB or eNodeB), a Next Generation NodeB (gNB or gNode B), a Wireless Fidelity (Wi-Fi) access point (AP), etc. In some embodiments, the network device 101 can include a relay station, an access point, an in-vehicle device, a wearable device, and the like. The network device 100 can include wireless connection devices for communication networks such as: a Global System for Mobile Communications (GSM) network, a Code Division Multiple Access (CDMA) network, a Wideband CDMA (WCDMA) network, an LTE network, a cloud radio access network (Cloud Radio Access Network, CRAN), an Institute of Electrical and Electronics Engineers (IEEE) 802.11-based network (e.g., a Wi-Fi network), an Internet of Things (IoT) network, a device-to-device (D2D) network, a next-generation network (e.g., a 5G network), a future evolved public land mobile network (Public Land Mobile Network, PLMN), or the like. A 5G system or network can be referred to as a new radio (New Radio, NR) system or network.

In FIG. 1, the wireless communications system 100 also includes a terminal device 103. The terminal device 103 can be an end-user device configured to facilitate wireless communication. The terminal device 103 can be configured to wirelessly connect to the network device 101 (via, e.g., via a wireless channel 105) according to one or more corresponding communication protocols/standards. The terminal device 103 may be mobile or fixed. The terminal device 103 can be a user equipment (UE), an access terminal, a user unit, a user station, a mobile site, a mobile station, a remote station, a remote terminal, a mobile device, a user terminal, a terminal, a wireless communications device, a user agent, or a user apparatus. Examples of the terminal device 103 include a modem, a cellular phone, a smartphone, a cordless phone, a Session Initiation Protocol (SIP) phone, a wireless local loop (WLL) station, a personal digital assistant (PDA), a handheld device having a wireless communication function, a computing device or another processing device connected to a wireless modem, an in-vehicle device, a wearable device, an Internet-of-Things (IoT) device, a device used in a 5G network, a device used in a public land mobile network, or the like. For illustrative purposes, FIG. 1 illustrates only one network device 101 and one terminal device 103 in the wireless communications system 100. However, in some instances, the wireless communications system 100 can include additional network device 101 and/or terminal device 103.

The terminal device 103 is configured to activate a list of one or more TCI states based on a medium access control (MAC) control element (CE). The terminal device 103 is further configured to receive DL control information (DCI) at a particular scheduling slot. Each TCI state includes a configuration for DL transmission, and/or a configuration for UL transmission. The terminal device 103 then receives DL control information (DCI) at a particular scheduling slot from the network device 101. The DCI indicates one of the activated TCI states, which is used to configure the UL and DL channels. The terminal device 103 can then configure UL and/or DL channels based on the configurations for the DL and UL transmissions. Accordingly, the terminal device 103 can configure multiple DL and UL beam operations though one reference signal.

In some embodiments, the terminal device 103 is configured to activate a list of one or more TCI states based on a MAC CE. Each TCI state includes a configuration for DL transmission and/or a configuration for UL transmission.

The terminal device 103 is also configured to receive, from a gNB, DCI at a particular scheduling slot. The DCI indicates one of the activated TCI states.

In some embodiments, the activated TCI states indicated by the DCI can include one or more of the following types of information: (a) QCL-TypeD data for the QCL relationship between one or two DL reference signals and the demodulation reference signal (DM-RS) ports of the PDSCH, the DM-RS port of the PDCCH, or the one or more channel-state information reference signal (CSI-RS) ports of a CSI-RS resource; (b) information for determining a spatial filter for transition of the PUSCH, the PUCCH, or a sounding reference signal (SRS) resource; (c) QCL-TypeD data for the PDSCH, the PDCCH, or a CSI-RS resource, and a spatial filter for the PUSCH, the PUCCH, or an SRS resource; (d) a pathloss reference signal for the PUSCH, the PUCCH, or an SRS resource; or (e) QCL-TypeD data for the PDSCH, the PDCCH, or a CSI-RS resource, and a spatial filter and a pathloss reference signal for the PUSCH, the PUCCH, or an SRS resource.

The terminal device 103 is also configured to configure at least one of: (i) a PDSCH and a PDCCH based on the configuration for DL transmission included in the activated TCI state indicated by the DCI, and (ii) a PUSCH and a PUCCH based on the configuration for UL transmission included in the activated TCI state indicated by the DCI.

In some embodiments, the terminal device 103 can be configured to receive the list of one or more TCI states and/or the MAC CE. For example, the list of one or more TCI states and/or the MAC CE can be from a base station, a gNB, etc.

In some embodiments, the list of one or more TCI states can include a list of one or more DL TCI states for common TCI state operation and a list of one or more UL TCI states for common TCI state operation. Each DL TCI state includes a configuration for DL transmission. Each UL TCI state includes a configuration for UL transmission. The configuration for DL Tx can include a QCL configuration. The configuration for UL transmission can include spatial-relation information for determining an UL spatial transmission filter.

In some embodiments, the terminal device 103 is also configured to determine a HARQ-ACK associated with the DCI. The HARQ-ACK can be determined based on one or more of: a timeline method for sending the HARQ-ACK, a method of choosing the PUCCH resource index, and/or other suitable schemes. The terminal device 103 can also report HARQ-ACK, for example, to the base station or the gNB.

For example, the terminal device 103 can be configured to report a HARQ-ACK associated with the DCI after receiving “N” symbols from the last symbol of the PDCCH providing a semi-persistent scheduling (SPS) PDSCH release. “N” can be a positive integer.

In some implementations, “N” can correspond to a value of “μ” which is the smallest SCS configuration between the PDCCH providing the common TCI state indication and a PUCCH carrying the HARQ-ACK information in response to the common TCI state indication.

In some embodiments, the TCI state can be indicated by indicators that include a bit-field having “N” bits (for example N=1, 2, 3, 4, 5 . . . etc.) and the value in the bit-field can indicate one of the TCI states that are activated by a MAC CE.

In some embodiments, the length of bit-field of TCI state can be shown as “┌log₂(M)┐.” “M” can be the number of configured TCI states in a higher layer and the value of the TCI state indicator can indicate one of those “M” TCI states configured in the higher layer.

In some embodiments, the PUCCH resource indicator can have a bit field and the length of the bit field can be 1, 2, 3, 4 or 5 bits. In some embodiments, the time to apply the TCI state can also be provided in a bit field which includes a value indicating a time point when the terminal device 103 can implement or apply the indicated TCI state. In some embodiments, a “PDCCH-to-HARQ_feedback” timing indicator can be used to indicate a time location of the PUCCH resource for the terminal device 103 to provided HARQ-ACK for the DCI format.

In some embodiments, the DCI format can be a “DCI format 1_0” which indicates one TCI state for a common TCI state operation. For example, the DCI format can include a “DCI format 1_0” with Cyclic Redundancy Check (CRC) scrambled by a Radio Network Temporary Identifier (RNTI) for common TCI state indication. The RNTI used for common TCI state indication can be called “TCI-RNTI.”

In some embodiments, one or more of the following information can be transmitted by the “DCI format 1_0” with the CRC scrambled by the TCI-RNTI: (i) a carrier indicator, having 0 or 3 bits; (ii) a TCI state indicator; (iii) a PUCCH resource indicator (e.g., having a bit field with a length of 1, 2, 3, 4 or 5 bits); (iv) time to apply the TCI state; (v) a PDCCH-to-HARQ_feedback timing indicator; and (vi) one or more reserved bits for aligning or adjusting the size of the DCI format.

In some embodiments, the following information can also be transmitted by the “DCI format 1_0” with CRC scrambled by Cell-RNTI (C-RNTI), configured-scheduling-RNTI (CS-RNTI), or modulation-and-coding-scheme RNTI (MCS-C-RNTI).

The information includes (a) an identifier for the DCI format (e.g., 1 bit, and the value of this bit field can always be set as 1, indicating a DL DCI format); (b) Frequency domain resource assignment (“┌log₂(N_{RB}^{DLBWP}(N_{RB}^{DLBWP}+1)/2)┐” bits, wherein “N_{RB}^{DLBWP}” is the number of resource block (RB) in the Band Width Part (BWP)); (c) a carrier indicator (e.g., 0 or 3 bits); (d) a TCI state indicator; (e). a PUCCH resource indicator as discussed above (e.g., the bit length can be 1, 2, 3, 4 or 5 bits); (f) time to apply the TCI state; (g) the PDCCH-to-HARQ_feedback timing indicator; and/or (h) one or more reserved bits for aligning or adjusting the size of the DCI format.

In some embodiments, the terminal device 103 can be configured with “M1” higher layer parameters “DL TCI state” which provides quasi co-location (QCL) configuration information for the reception of DL channels and reference signals. The terminal device 103 can be configured with “M2” higher layer parameters “UL TCI state” which provides spatial setting information for the transmission of UL channels and reference signals.

In each DL TCI state, the terminal device 103 can be provided with one or more of the following information: one reference signal providing “QCL-TypeD” quasi co-location type for the quasi co-location relationship between one or two DL reference signals and the demodulation reference signal (DM-RS) port(s) of the PDSCH, the DM-RS ports of the PDCCH, or the CSI-RS port(s) of a CSI-RS resource.

In each UL TCI state, the terminal device 103 can be provided with one or more of the following information: (i) one reference signal providing a pathloss reference signal for PUSCH, PUCCH, or the SRS resource; (ii) one reference signal providing both (a) “QCL-TypeD” or PDSCH, PDCCH, or channel state information reference signal (CSI-RS) resource and (b) spatial filter and path loss reference signal for PUSCH, PUCCH or the SRS resource.

In some embodiments, the present technology can use DCI signaling to indicate a first DL TCI state and/or a second UL TCI state to the terminal device 103. After the terminal device 103 receives the DCI signaling, the terminal device 103 can be requested to (i) apply the QCL information provided by the first DL TCI state to receive PDCCH, PDSCH and CSI-RS resource and (ii) apply information of spatial filter and pathloss RS provided by the second UL TCI state to transmit PUSCH, PUCCH and SRS resource starting from a pre-defined time point.

In a DCI format providing common TCI state indication, the terminal device 103 can be provided with one or more of the following information: (1) a carrier indicator for indicating the cell where the indicated TCI state can be applied; (2) a DL TCI state indicator for indicating one DL TCI state; (3) a UL TCI state indicator for indicating one UL TCI state; (4) a PUCCH resource indicator to indicate index of PUCCH resource for the UE to provide HARQ-ACK information (e.g., the length of bit field can be 1, 2, 3, 4 or 5 bits);(5) time to apply the TCI state; and (6) a PDCCH-to-HARQ_feedback timing indicator.

In some embodiments, the bit-field of the TCI state indicator can have N bits (e.g., 1-5, etc.) and the value of the TCI state indicator can correspond to or indicate one of the TCI states that are activated by a MAC CE. In one example, the length of bit-field of TCI state is ┌log₂(M)┐, wherein “M” is the number of configured TCI states in a higher layer and the value of TCI state indicator indicates one of those “M” TCI states configured in the higher layer.

The present disclosure also provides embodiments for using HARQ-ACK and PUCCH for DCI. In some embodiments, the terminal device 103 can receive a DCI format that provides common TCI state indication for DL reception and UL transmission. The terminal device 103 can be requested to provide HARQ-ACK information in response to the DCI format that indicates the TCI state(s) for the common TCI state operation. The terminal device 103 can be expected to provide HARQ-ACK information in response to a first DCI format indicating TCI state(s) for common TCI state operation after N symbols from the last symbol of a PDCCH providing the first DCI format.

In some embodiments, the terminal device 103 can receive a DCI format “X” that provides common TCI state indication for common TCI state operation. The terminal device 103 can be expected to provide HARQ-ACK information in response to a common TCI state indication after N symbols from the last symbol of a PDCCH providing a Semi Persistent Scheduling (SPS) PDSCH release.

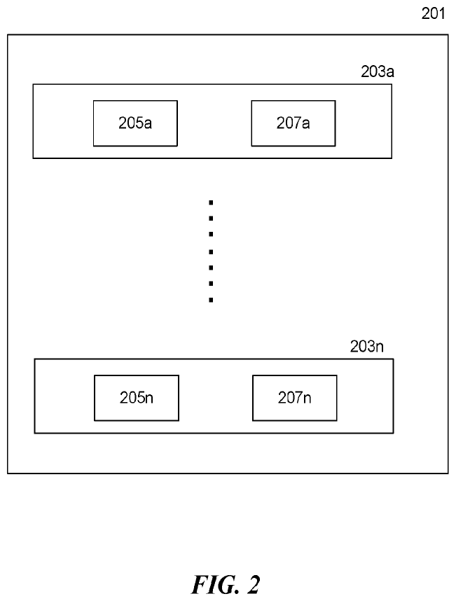

FIG. 2 is a schematic diagram illustrating a list of TCI states in accordance with one or more implementations of the present disclosure. As shown in FIG. 2, a TCI state indicator 201 can include multiple TCI states 203a-203n. The TCI state 203a can include a configuration for DL transmission 205a and a configuration for UL transmission 207a. Similarly, the TCI state 203n can include a configuration for DL transmission 205n and a configuration for UL transmission 207n. The TCI state 203a-203n can be activated based on an MAC CE. The configurations for DL/UL transmissions 205a-205n and 207a-207n can be used by a terminal device or UE to configure PDSCH/PDCCH and/or PUSCH/PUCCH.

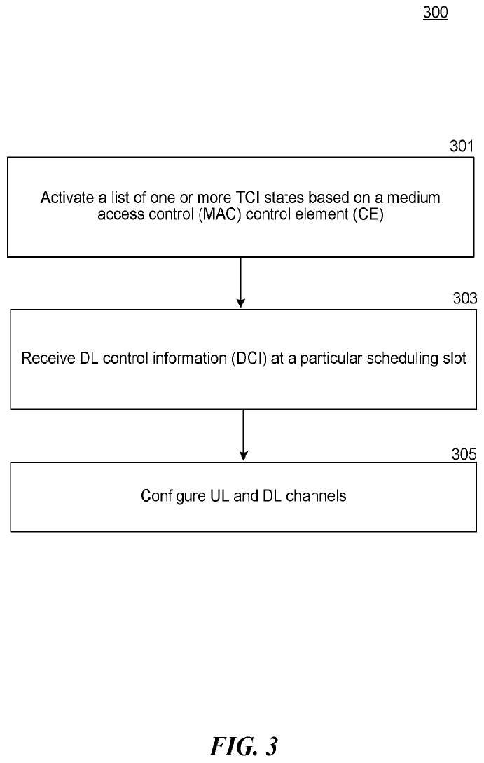

FIG. 3 is a flowchart of a method 300 in accordance with one or more implementations of the present disclosure. The method 300 can be implemented by a terminal device or UE (e.g., the terminal device 103).

At block 301, the method 300 includes activating a list of one or more TCI states based on an MAC CE. Each TCI state includes a configuration for DL transmission and/or a configuration for UL transmission.

At block 303, the method 300 continues by receiving DCI a particular scheduling slot from a base station or a next generation node B base station (gNB). The DCI indicates one of the activated TCI states.

At block 305, the method 300 continues by configuring UL and/or DL channels based on the activated TCI states. For example, this step can include configuring a PDSCH and a PDCCH based on the configuration for DL transmission included in the activated TCI state indicated by the DCI. As another example, this step can also include configuring a PUSCH and a PUCCH based on the configuration for UL transmission included in the activated TCI state indicated by the DCI.

In some embodiments, the method 300 can further include (i) receiving, from the gNB, the list of one or more TCI states; and (ii) receiving, from the gNB, the MAC CE.

In some cases, the list of one or more TCI states can include (1) a list of one or more DL TCI states for common TCI state operation (each DL TCI state includes a configuration for DL transmission); and (2) a list of one or more UL TCI states for common TCI state operation (each UL TCI state includes a configuration for UL transmission).

In some embodiments, the configuration for DL transmission can include a quasi co-location (QCL) configuration. The configuration for UL Tx can include spatial-relation information for determining an UL spatial transmission filter.

The method 300 can also include determining a HARQ-ACK associated with the DCI, based on one or more of: (a) a timeline method for sending the HARQ-ACK, or (b) a method of choosing the PUCCH resource index. The method 300 can also include reporting the HARQ-ACK to the gNB.

In some embodiments, the activated TCI states indicated by the DCI can include one or more of the following types of information: (a) QCL-TypeD data for the QCL relationship between one or two DL reference signals and the demodulation reference signal (DM-RS) ports of the PDSCH, the DM-RS port of the PDCCH, or the one or more channel-state information reference signal (CSI-RS) ports of a CSI-RS resource; (b) information for determining a spatial filter for transition of the PUSCH, the PUCCH, or a sounding reference signal (SRS) resource; (c) QCL-TypeD data for the PDSCH, the PDCCH, or a CSI-RS resource, and a spatial filter for the PUSCH, the PUCCH, or an SRS resource; (d) a pathloss reference signal for the PUSCH, the PUCCH, or an SRS resource; or (e) QCL-TypeD data for the PDSCH, the PDCCH, or a CSI-RS resource, and a spatial filter and a pathloss reference signal for the PUSCH, the PUCCH, or an SRS resource. In some embodiments, the activated TCI state indicated by the DCI includes exactly one type of foregoing information.

The method 300 can also include scrambling a cyclic redundancy check (CRC) of the DCI for common TCI state indication based on a dedicated radio network temporary identifier (RNTI).

The method 300 can also include reporting a HARQ-ACK associated with the DCI after receiving N symbols from the last symbol of the PDCCH providing a semi-persistent scheduling (SPS) PDSCH release. “N” is a positive integer.

In some implementations, “N” corresponds to a value of “μ,” which is the smallest subcarrier spacing (SCS) configuration between the PDCCH providing the common TCI state indication and a PUCCH carrying the HARQ-ACK information in response to the common TCI state indication.

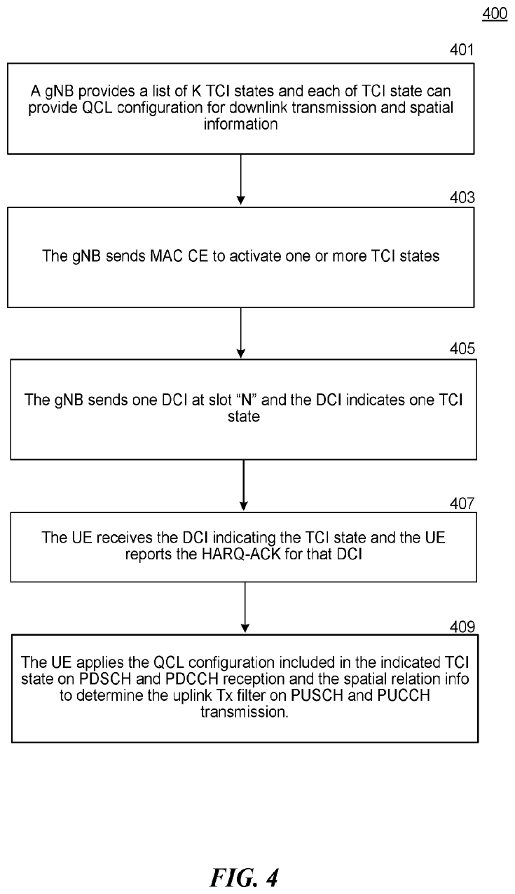

FIG. 4 is a flowchart of a method 400 in accordance with one or more implementations of the present disclosure. The method 400 can be implemented by a terminal device or UE (e.g., the terminal device 103).

At block 401, a gNB provides a list of “K” TCI states. Each of the TCI state can provide QCL configuration for DL transmission and spatial relation information for determining UL spatial transmission filer for UL transmission.

At block 403, the gNB sends an MAC CE to activate one or more TCI states. At block 405, the gNB sends one DCI at slot “N” and the DCI indicates at least one activated TCI states.

At block 407, a UE receives the DCI indicating the activated TCI state and then the UE can report HARQ-ACK for that DCI. At block 409, the UE applies the QCL configuration included in the indicated TCI state on PDSCH and PDCCH reception and the spatial relation information so as to determine the uplink transmission filter on PUSCH and PUCCH transmission.

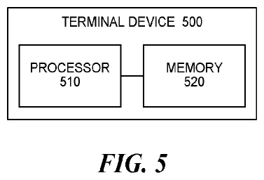

FIG. 5 is a schematic block diagram of a terminal device 500 (e.g., an example of the terminal device 103 of FIG. 1) in accordance with one or more implementations of the present disclosure. As shown in FIG. 5, the terminal device 500 includes a processing unit 510 (e.g., a DSP, a CPU, a GPU, etc.) and a memory 520. The processing unit 510 can be configured to implement instructions that correspond to the method 300 of FIG. 3 and the method 400 of FIG. 4 and/or other aspects of the implementations described above.

It should be understood that the processor in the implementations of this technology may be an integrated circuit chip and has a signal processing capability. During implementation, the steps in the foregoing method may be implemented by using an integrated logic circuit of hardware in the processor or an instruction in the form of software. The processor may be a general-purpose processor, a digital signal processor (DSP), an application specific integrated circuit (ASIC), a field programmable gate array (FPGA) or another programmable logic device, a discrete gate or transistor logic device, and a discrete hardware component. The methods, steps, and logic block diagrams disclosed in the implementations of this technology may be implemented or performed. The general-purpose processor may be a microprocessor, or the processor may be alternatively any conventional processor or the like. The steps in the methods disclosed with reference to the implementations of this technology may be directly performed or completed by a decoding processor implemented as hardware or performed or completed by using a combination of hardware and software modules in a decoding processor. The software module may be located at a random-access memory, a flash memory, a read-only memory, a programmable read-only memory or an electrically erasable programmable memory, a register, or another mature storage medium in this field. The storage medium is located at a memory, and the processor reads information in the memory and completes the steps in the foregoing methods in combination with the hardware thereof.

It may be understood that the memory in the implementations of this technology may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM) or a flash memory. The volatile memory may be a random-access memory (RAM) and is used as an external cache. For exemplary rather than limitative description, many forms of RAMs can be used, and are, for example, a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synchronous link dynamic random-access memory (SLDRAM), and a direct Rambus random-access memory (DR RAM). It should be noted that the memories in the systems and methods described herein are intended to include, but are not limited to, these memories and memories of any other suitable type.

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the described technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative implementations or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

In the Detailed Description, numerous specific details are set forth to provide a thorough understanding of the presently described technology. In other implementations, the techniques introduced here can be practiced without these specific details. In other instances, well-known features, such as specific functions or routines, are not described in detail in order to avoid unnecessarily obscuring the present disclosure. References in this description to “an implementation/embodiment,” “one implementation/embodiment,” or the like mean that a particular feature, structure, material, or characteristic being described is included in at least one implementation of the described technology. Thus, the appearances of such phrases in this specification do not necessarily all refer to the same implementation/embodiment. On the other hand, such references are not necessarily mutually exclusive either. Furthermore, the particular features, structures, materials, or characteristics can be combined in any suitable manner in one or more implementations/embodiments. It is to be understood that the various implementations shown in the figures are merely illustrative representations and are not necessarily drawn to scale.

Several details describing structures or processes that are well-known and often associated with communications systems and subsystems, but that can unnecessarily obscure some significant aspects of the disclosed techniques, are not set forth herein for purposes of clarity. Moreover, although the following disclosure sets forth several implementations of different aspects of the present disclosure, several other implementations can have different configurations or different components than those described in this section. Accordingly, the disclosed techniques can have other implementations with additional elements or without several of the elements described below.

Many implementations or aspects of the technology described herein can take the form of computer- or processor-executable instructions, including routines executed by a programmable computer or processor. Those skilled in the relevant art will appreciate that the described techniques can be practiced on computer or processor systems other than those shown and described below. The techniques described herein can be implemented in a special-purpose computer or data processor that is specifically programmed, configured, or constructed to execute one or more of the computer-executable instructions described below. Accordingly, the terms “computer” and “processor” as generally used herein refer to any data processor. Information handled by these computers and processors can be presented at any suitable display medium. Instructions for executing computer- or processor-executable tasks can be stored in or on any suitable computer-readable medium, including hardware, firmware, or a combination of hardware and firmware. Instructions can be contained in any suitable memory device, including, for example, a flash drive and/or other suitable medium.

The term “and/or” in this specification is only an association relationship for describing the associated objects, and indicates that three relationships may exist, for example, A and/or B may indicate the following three cases: A exists separately, both A and B exist, and B exists separately.

These and other changes can be made to the disclosed technology in light of the above Detailed Description. While the Detailed Description describes certain examples of the disclosed technology, as well as the best mode contemplated, the disclosed technology can be practiced in many ways, no matter how detailed the above description appears in text. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the invention is not limited, except as by the appended claims. In general, the terms used in the following claims should not be construed to limit the disclosed technology to the specific examples disclosed in the specification, unless the above Detailed Description section explicitly defines such terms.

A person of ordinary skill in the art may be aware that, in combination with the examples described in the implementations disclosed in this specification, units and algorithm steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/we claim:

1. A method, executable by a user equipment (UE), comprising:
activating a list of one or more transmission configuration indicator (TCI) states based on a medium access control (MAC) control element (CE), wherein each TCI state includes:
a configuration for downlink (DL) transmission (Tx), and/or
a configuration for uplink (UL) Tx;
receiving, from a next generation node B base station (gNB), DL control information (DCI) at a particular scheduling slot, wherein the DCI indicates one of the activated TCI states; and
configuring at least one of:
a physical downlink shared channel (PDSCH) and a physical downlink control channel (PDCCH) based on the configuration for DL Tx included in the activated TCI state indicated by the DCI, and
a physical uplink shared channel (PUSCH) and a physical uplink control channel (PUCCH) based on the configuration for UL Tx included in the activated TCI state indicated by the DCI.

2. The method of claim 1, further comprising:
receiving, from the gNB, the list of one or more TCI states; and
receiving, from the gNB, the MAC CE.

3. The method of claim 1, wherein the list of one or more TCI states comprises:
a list of one or more DL TCI states for common TCI state operation, wherein each DL TCI state includes a configuration for DL Tx; and
a list of one or more UL TCI states for common TCI state operation, wherein each UL TCI state includes a configuration for UL Tx.

4. The method of claim 1, wherein the configuration for DL Tx includes a quasi co-location (QCL) configuration, and wherein the configuration for UL Tx includes spatial-relation information for determining an UL spatial Tx filter.

5. The method of claim 1, further comprising:
determining a Hybrid Automatic Repeat Request (HARQ) acknowledgment (ACK) associated with the DCI, based on one or more of:
a timeline method for sending the HARQ-ACK, or
a method of choosing the PUCCH resource index; and
reporting, to the gNB, the HARQ-ACK.

6. The method of claim 1, wherein the activated TCI state indicated by the DCI includes one or more of the following types of information:
(1) QCL-TypeD data for the QCL relationship between one or two DL reference signals and the demodulation reference signal (DM-RS) ports of the PDSCH, the DM-RS port of the PDCCH, or the one or more channel-state information reference signal (CSI-RS) ports of a CSI-RS resource;
(2) information for determining a spatial filter for Tx of the PUSCH, the PUCCH, or a sounding reference signal (SRS) resource;
(3) QCL-TypeD data for the PDSCH, the PDCCH, or a CSI-RS resource, and a spatial filter for the PUSCH, the PUCCH, or an SRS resource;
(4) a pathloss reference signal for the PUSCH, the PUCCH, or an SRS resource; or
(5) QCL-TypeD data for the PDSCH, the PDCCH, or a CSI-RS resource, and a spatial filter and a pathloss reference signal for the PUSCH, the PUCCH, or an SRS resource.

7. The method of claim 6, wherein the activated TCI state indicated by the DCI includes exactly one type of said information.

8. The method of claim 1, further comprising scrambling a cyclic redundancy check (CRC) of the DCI for common TCI state indication based on a dedicated radio network temporary identifier (RNTI).

9. The method of claim 1, further comprising reporting a HARQ-ACK associated with the DCI after receiving N symbols from the last symbol of the PDCCH providing a semi-persistent scheduling (SPS) PDSCH release, wherein N is a positive integer.

10. The method of claim 9, wherein N corresponds to a value of μ, which is the smallest subcarrier spacing (SCS) configuration between the PDCCH providing the common TCI state indication and a PUCCH carrying the HARQ-ACK information in response to the common TCI state indication.

11. A UE configured to:
activate a list of one or more TCI states based on a MAC CE, wherein each TCI state includes:
a configuration for DL Tx, and/or
a configuration for UL Tx;
receive, from a gNB, DCI at a particular scheduling slot, wherein the DCI indicates one of the activated TCI states; and
configure at least one of:
a PDSCH and a PDCCH based on the configuration for DL Tx included in the activated TCI state indicated by the DCI, and
a PUSCH and a PUCCH based on the configuration for UL Tx included in the activated TCI state indicated by the DCI.

12. The UE of claim 11, further configured to:
receive, from the gNB, the list of one or more TCI states; and
receive, from the gNB, the MAC CE.

13. The UE of claim 11, wherein the list of one or more TCI states comprises:
a list of one or more DL TCI states for common TCI state operation, wherein each DL TCI state includes a configuration for DL Tx; and
a list of one or more UL TCI states for common TCI state operation, wherein each UL TCI state includes a configuration for UL Tx.

14. The UE of claim 11, wherein the configuration for DL Tx includes a QCL configuration, and wherein the configuration for UL Tx includes spatial-relation information for determining an UL spatial Tx filter.

15. The UE of claim 11, further configured to:
determine a HARQ-ACK associated with the DCI, based on one or more of:
a timeline method for sending the HARQ-ACK, or
a method of choosing the PUCCH resource index; and
report, to the gNB, the HARQ-ACK.

16. The UE of claim 11, wherein the activated TCI state indicated by the DCI includes one or more of the following types of information:
(1) QCL-TypeD data for the QCL relationship between one or two DL reference signals and the DM-RS ports of the PDSCH, the DM-RS port of the PDCCH, or the one or more CSI-RS ports of a CSI-RS resource;
(2) information for determining a spatial filter for Tx of the PUSCH, the PUCCH, or an SRS resource;
(3) QCL-TypeD data for the PDSCH, the PDCCH, or a CSI-RS resource, and a spatial filter for the PUSCH, the PUCCH, or an SRS resource;
(4) a pathloss reference signal for the PUSCH, the PUCCH, or an SRS resource; or
(5) QCL-TypeD data for the PDSCH, the PDCCH, or a CSI-RS resource, and a spatial filter and a pathloss reference signal for the PUSCH, the PUCCH, or an SRS resource.

17. The UE of claim 16, wherein the activated TCI state indicated by the DCI includes exactly one type of said information.

18. The UE of claim 11, further configured to scramble a CRC of the DCI for common TCI state indication based on a dedicated RNTI.

19. The UE of claim 11, further configured to report a HARQ-ACK associated with the DCI after receiving N symbols from the last symbol of the PDCCH providing a SPS PDSCH release, wherein N is a positive integer.

20. The UE of claim 19, wherein N corresponds to a value of μ, which is the smallest SCS configuration between the PDCCH providing the common TCI state indication and a PUCCH carrying the HARQ-ACK information in response to the common TCI state indication.
